(19) United States
(12) Patent Application Publication
(10) Pub. No.: US 2009/0166416 A1
(43) Pub. Date: Jul. 2, 2009

(54) INVENTORY SYSTEM AND PROCESS

(76) Inventor: Ronald Stephen Fleming, Victoria (AU)

Correspondence Address: NIXON & VANDERHYE, PC, 901 NORTH GLEBE ROAD, 11TH FLOOR, ARLINGTON, VA, 22203, US

(21) Appl. No.: 12/095,562

(22) PCT Filed: Dec. 2, 2005
(86) PCT No.: PCT/AU05/01828

§ 371 Date: Jul. 30, 2008

(30) Foreign Application Priority Data
Dec. 3, 2004 (AU) 2004906930

(51) Int. Cl. G06F 19/00

(52) U.S. Cl. 235/385

(57) ABSTRACT

An inventory system for determining receipt of components of an article, the components having identification labels (400) of a set of labels (300) attached thereto, the system being adapted to generate inventory data identifying receipt of said components on the basis of the remaining identification labels (602) of said set (300).

### FIELD OF THE INVENTION

The present invention relates to an inventory system and process, a process for determining receipt of components of an article, and a set of identification labels, and in particular to a system and process for generating an inventory or list of components of an article.

### BACKGROUND

Businesses maintaining inventories of components or parts of complex articles are often faced with the difficulty of identifying which components or parts of one or more articles are in stock, and how many of each component are in stock. For example, a complex article such as a car or a motorcycle contains hundreds if not thousands of individual components, and the task of identifying and recording each individual component may be beyond the capabilities of some businesses, such as a car or motorcycle wrecking yard that provides spare parts for motorcycles, for example. The time and effort involved in identifying and recording each individual component of a car or motorcycle brought to a wrecker's yard is prohibitive, and as a result, the inventory of components is simply not recorded. A customer wishing to purchase a particular component of a particular car or motorcycle must therefore wander about the wrecker's yard in the hope of manually locating each desired component. There may be little purpose in storing many such components if their presence is unknown and they cannot be easily located or identified.

It is desired to provide an inventory system and process, a process for determining receipt of components of an article, and a set of identification labels that alleviate one or more difficulties of the prior art, or at least provide a useful alternative.

### SUMMARY OF THE INVENTION

In accordance with the present invention, there is provided a process for determining receipt of components of an article, the components having identification labels selected from a set of identification labels attached thereto, the process including generating inventory data identifying receipt of said components on the basis of the remaining one or more identification labels of said set of identification labels.

The present invention also provides an inventory process, including generating inventory data identifying components of a received article on the basis of identification data of one or more identification labels of a set of identification labels, the other labels of said set of identification labels having been attached to respective components of said received article.

The present invention also provides an inventory process, including generating a set of identification labels for attachment to respective components of an article, each of said identification labels including identification data identifying a corresponding component of said article.

The present invention also provides an inventory system for determining receipt of components of an article, the components having identification labels of a set of labels attached thereto, the system being adapted to generate inventory data identifying receipt of said components on the basis of the remaining identification labels of said set.

The present invention also provides an inventory system adapted to generate inventory data identifying components of a received article on the basis of identification data of one or more identification labels of a set of identification labels, the other labels of said set of identification labels having been attached to respective components of said received article.

The present invention also provides a set of identification labels for attachment to respective components of an article, each of said identification labels including identification data identifying a corresponding component of said article.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of an inventory system connected to client systems via a communications network;

FIG. 2 is a flow diagram of an inventory process executed by the inventory system;

FIG. 3 is a schematic diagram of a set of labels generated by the inventory system for attachment to an article of a selected type;

FIG. 4 is a schematic diagram of a label sheet of the set of labels;

FIG. 5 is a schematic diagram of an individual label of the label sheet; and

FIG. 6 is a schematic diagram of the label sheet following attachment of some labels to corresponding components of an article of the selected type.

### DETAILED DESCRIPTION OF THE PREFERRED EMBODIMENTS

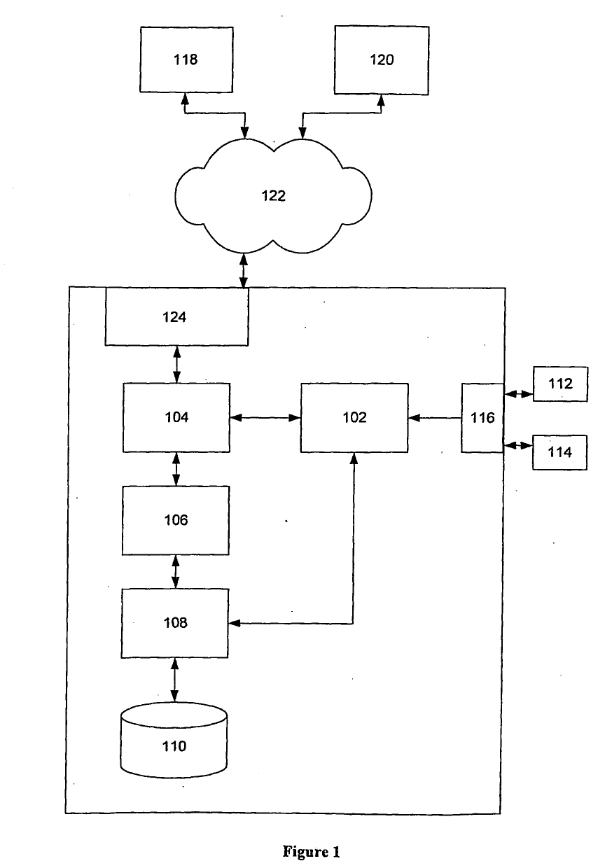

As shown in FIG. 1, an inventory system includes inventory modules 102, a web server 104, a scripting language module 106, a database interface module 108, and a database 110. The inventory system also includes a printer 112 and a barcode scanner 114, which communicate with the inventory modules 102 via a communications interface 116. The web server 104 can be accessed by client systems 118, 120 via a communications network 122 and a network interface connector 124 of the inventory system.

The inventory system uses an inventory process to generate an inventory of components of one or more articles. In the described embodiment, the inventory system and the client systems 118, 120 are standard computer systems, such as Intel Architecture IA-32 personal computers or servers, and the inventory process is implemented as software modules, being the inventory modules 102, stored on non-volatile storage associated with the computer system. However, it will be apparent that at least parts of the inventory process can be alternatively implemented by dedicated hardware components, such as application-specific integrated circuits (ASICs). The web server 104 is a standard web server, such as a Microsoft Internet Information Services (IIS) web server or Apache (available at HTTP://www.apache.org), the scripting language module 106 is a standard scripting language module such as Microsoft Active Server Pages (ASP) or PHP5 (available at HTTP://php.net), and the database interface module 108 is a standard structured query language (SQL) database interface module such as Microsoft SQL Server, or MySQL (available at HTTP://www.mysql.com), providing access to the SQL database 110. The communications interface 116 is a standard computer interface such as a universal serial bus (USB) port, and the communications network 122 may be a local area network or a wide-area network such as the Internet.

The inventory modules 102 include user interface scripts prepared in hypertext markup language (HTML) PHP or ASP scripting language, and JavaScript, image data files, common gateway interface (CGI) scripts, and executable applications invoked by the scripts. PHP or ASP scripts are interpreted by the scripting language module 106 to dynamically generate HTML pages, and in some instances also incorporate SQL commands for accessing the SQL database 110 via the database interface module 108.

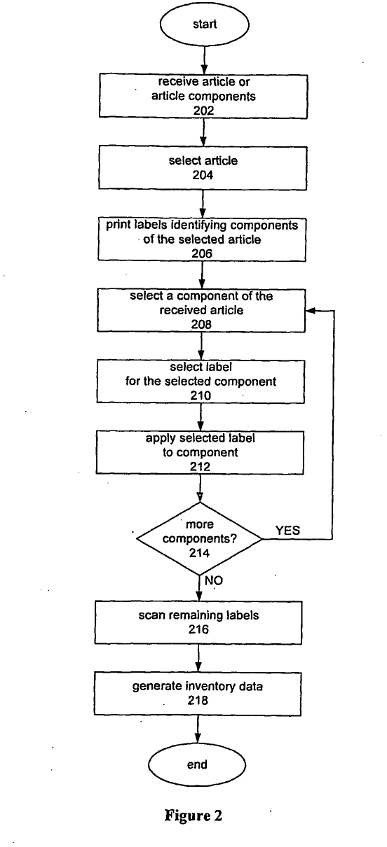

The inventory system is particularly useful when applied to generating and managing an inventory of components of one or more complex articles, where each article comprises many such components. For example, the inventory system allows an operator of a motorcycle wrecker's business to generate and maintain their inventory of motorcycle components. When a motorcycle is brought into the wrecker's yard for disassembly into its components, the inventory system uses the inventory process, as shown in FIG. 2, to generate an inventory of the motorcycle's components that can be made available for purchase by prospective customers.

The inventory process begins at step 202, when an article, in this case a motorcycle, is brought into the wrecker's yard and is disassembled into its various components. An employee of the wrecker then accesses the inventory system via a standard web browser application executing on one of the client systems 118, 120. The inventory modules 102 provide HTML data in the form of web pages that are sent to the employee's web browser application by the web server 104. By navigating menus and hyperlinks in the displayed web pages, the employee selects the type of the article from one or more drop down menus at step 204. In this case, the employee selects the particular type of motorcycle whose components are to be added to the wrecker's inventory. For example, the motorcycle may be a 1982 Suzuki GT 250 motorcycle, and the selection of the Suzuki make/manufacturer from a drop down menu of available makes/manufacturers populates a second drop down menu with known models of Suzuki motorcycles. The employee then selects the model GT 250 from the second drop-down menu, and this action populates a third drop down menu with known years of production of this model of motorcycle. The employee then selects the year 1982 from this menu. This selection process at step 202 allows the inventory system to retrieve a complete list of all possible components of the 1982 Suzuki GT 250 from the database 110. The list of components includes all known options or extras for the selected motorcycle model and year. If, however, the particular motorcycle is not known to the system, then the employee can select a generic or unknown option from one or more of the three menus described above. For example, the motorcycle may be specified as “Suzuki GT250 (unknown year)”, “Suzuki (Model and year unknown)”, “Generic street bike”, and so on. In such cases, the system retrieves an appropriate generic list of parts for the motorcycle from the database 110. The employee can edit this list if desired, for example, to remove components that are not appropriate for the article, and can then save the edited list for future re-use.

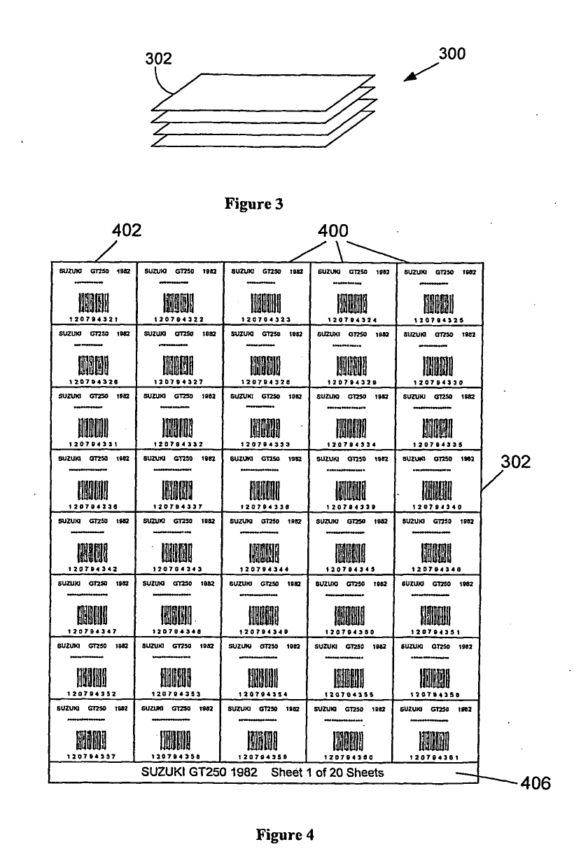

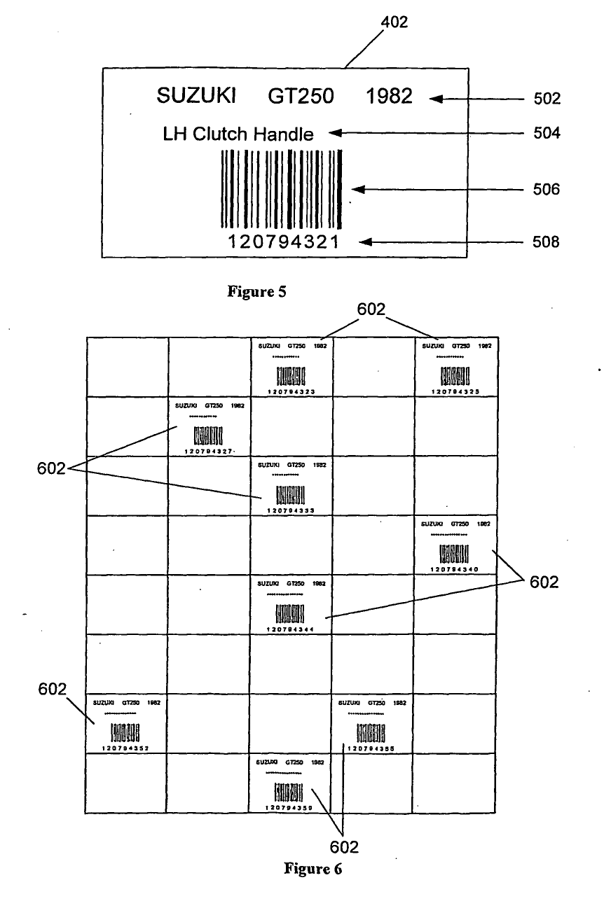

Having retrieved a list of components appropriate to the particular motorcycle, the system then prints a complete set of labels 300 on the printer 112 at step 206, typically in the form of one or more sheets of labels 302, as shown in FIG. 3. As shown in FIG. 4, each of the sheets 302 provides a rectangular array of individual labels 400 backed with adhesive, with each label 400 including identification data identifying a particular component of the selected motorcycle. For example, as shown in FIG. 5, a particular label 402 includes article description text 502, identifying the selected motorcycle, in this case “Suzuki GT 250 1982”, component description text 504, in this case “left hand clutch handle”, a unique barcode 506, and a human-readable unique identification number 508 corresponding to the barcode 506.

In the case of a very complex article with so many parts that the set of labels 300 includes many sheets 302, the labels 400 are arranged in groups corresponding to respective portions of the article. For example, in the case of a motorcycle, one or more sheets might be grouped as “front wheel assembly”, and another as “clutch components”, and so on. This greatly facilitates the identification of the appropriate label for a particular component, as labels from the appropriate one or more sheets can be applied to the components of each motorcycle portion at a time.

Having printed the label sheets 300, a particular component of the motorcycle is selected at step 208. For example, the employee might begin by selecting the left-hand clutch handle of the motorcycle. At step 210, the employee locates and selects the appropriate label corresponding to the selected component, in this case the label 402 illustrated in FIG. 5. At step 212, the selected label is peeled from its sheet and applied to the selected component. The adhesive backing on the label ensures that it adheres to a surface of the component. However, if the label cannot be directly applied to the article (for example, if the component is particularly dirty or greasy) the label can be applied to a tag that is tied or otherwise attached to the component. The component can then be put aside for storage with other motorcycle components.

If, at step 214, more motorcycle components remain to be classified, then the process loops back to select the next component at step 208. However, any components that are not in acceptable condition or are not to be included in the inventory of components for any other reason can be omitted. Eventually, all of the motorcycle components (excepting any that are not to be included in the inventory) will have been labelled. Because the set of labels 300 includes labels for all possible components of the selected motorcycle, it is unlikely that all of the labels of the set 300 will have been used. Thus some of the label sheets 302 will have had all of their labels removed, others of the sheets 302 may have had only a subset of the labels removed with one or more individual labels remaining, and yet other sheets may have had no labels removed at all.

For example, FIG. 6 shows the sheet 302 after all of the motorcycle's components have been labelled, leaving nine remaining labels 602 on the sheet 302. The remaining labels 602 identify components that were not present of the motorcycle or are not to be included in the inventory, perhaps due to excessive damage or some other reason. At step 216, any remaining labels are then scanned. This can be performed manually by using the barcode scanner 114 to scan each individual remaining label, or alternatively and preferably, each label sheet having a subset of one or more remaining labels can be scanned on a flat bed scanner (not shown) of the system, and the resulting image analysed by one of the inventory modules 102 to determine the barcodes of those remaining labels. The scanned barcodes identify components that were not present or are otherwise not to be included in the inventory. Sheets that have had no labels removed, or all of the labels removed, can either be scanned as described above, or can be omitted from the scanned sheets. In such cases the system generates a prompt and displayed it to the employee on a display device of the system. The prompt identifies the missing label sheets and requests that those missing sheets are either scanned, or are identified as being either empty or full of labels. In response, the employee can specify that specific ones of the missing sheets are either full (i.e., no labels removed), or empty (i.e., all labels removed), or can simply scan the missing sheets. In the case of a scanned empty sheet, the remaining sheet identification label 406 identifies the empty sheet.

At step 218, the system generates inventory data identifying all of the received motorcycle components (excepting any that are not to be included in the inventory, as described above) by subtracting the components identified by the remaining label barcodes from the complete list of components on the set of labels 300 printed at step 206. The database 110 is then updated to include the new inventory data. This ends the inventory process.

It will be apparent from the above, that the inventory process greatly facilitates the identification of the presence of individual components of articles having many components, and thus the generation of an inventory of those components. By generating identification labels for all possible components and then determining the presence of components by subtracting any remaining components from the complete list of possible components, the time and effort involved to record the presence of each component is reduced to the time required to locate the corresponding label and attach it to the component. All that a user of the system needs to do is to select the appropriate article, print a complete set of identification labels for that article, apply labels to components of the article, and scan any remaining labels. Because the number of remaining labels is typically much smaller than the number of applied labels, the scanning effort is greatly reduced. Furthermore, because the remaining labels can be scanned in sheet form this further reduces the time and effort required.

Subsequently, an employee of the wrecker can generate a complete list of inventory, optionally classified or restricted to particular makes, models, and/or years of motorcycles. The inventory can also be read by a remote user of the Internet via a standard web browser application executing on a personal computer to determine whether a desired motorcycle component is available. Once a component is labelled, its label can be scanned to identify the component and any attributes identified by the label.

In an alternative embodiment, the labels include attribute information for each component. For example, the set of labels can include several labels for each component, each identifying a corresponding status or condition (e.g., perfect, good, fair, poor) for the component. Thus when selecting a label for each component, the user selects the label that most closely corresponds to the actual condition of that component. Alternatively, the labels for each component could identify other attributes of the component, such as its colour, for example. Many labels can be provided for each component, specifying different values for two or more attributes. For example, a selected label may identify the component, and two or more attributes, including condition of the component and its year of manufacture.

In yet a further alternative embodiment, the inventory data generated at step 218 is automatically sent to a centralized component management system (not shown) for sale or other form of distribution of the received components. The operators of the centralized component management system may charge a fee for listing the components identified by the received inventory data. The centralized component management system can thus provide access to components from any number of component warehouses or businesses. The centralized component management system may be, an e-commerce or auction web site such as eBay. A predetermined price and/or minimum bid amount could be retrieved from the database 110 and associated with each component, which may take into account any known attributes of the component (its condition or year of manufacture, for example).

In yet a further alternative embodiment, at least part of the identification data is stored in radio-frequency identification (RFID) tags attached to or incorporated within the set of labels.

Although the inventory system and process have been described above in the context of generating, accessing, and maintaining an inventory of components of motorcycles, it will be apparent that the inventory system and process are equally applicable to inventories of components of other types of vehicles or indeed any types of articles or systems comprising many components or constituents.

Many modifications will be apparent to those skilled in the art without departing from the scope of the present invention as herein described with reference to the accompanying drawings.

1. A process for determining receipt of components of an article, the components having identification labels selected from a set of identification labels attached thereto, the process including generating inventory data identifying receipt of said components on the basis of the remaining one or more identification labels of said set of identification labels.

2. A process as claimed in claim 1, wherein each identification label of the set of identification labels includes identification data for identifying a corresponding component of an article.

3. An inventory process, including generating inventory data identifying components of a received article on the basis of identification data of one or more identification labels of a set of identification labels, the other labels of said set of identification labels having been attached to respective components of said received article.

4. A process as claimed in claim 1, including determining the identification data of the one or more identification labels.

5. A process as claimed in claims 4, wherein said determining includes scanning the identification data of the one or more identification labels.

6. A process as claimed in claim 5, wherein said step of scanning includes optically scanning one or more barcodes of the one or more identification labels.

7. A process as claimed in claim 5, wherein said step of scanning includes scanning one or more RFID tags of the one or more identification labels.

8. A process as claimed in claim 5, wherein the set of identification labels are provided in the form of one or more label sheets each including a respective subset of said identification labels, and the step of scanning includes scanning at least one of the label sheets from which some of the identification labels have been removed to determine the identification data of the one or more identification labels.

9. A process as claimed in claim 1, including providing said set of identification labels for attachment to respective components of an article of a selected type, each of said labels including identification data for identifying a corresponding component of an article of said type.

10. A process as claimed in claim 9, wherein said step of providing includes printing said set of identification labels.

11. A process as claimed in claim 9, wherein said step of providing includes:
selecting a type of said received article on the basis of received type selection data;
generating a list of possible components of an article of the selected type; and
generating said set of identification labels on the basis of said list.

12. A process as claimed in claim 1, including updating an inventory of components on the basis of said inventory data.

13. A process as claimed in any claim 12, wherein the inventory is accessible from a web server.

14. A process as claimed in claim 1, including updating a database on the basis of said inventory data.

15. A process as claimed in claim 1, including sending said inventory data to a remote system over a communications network.

16. A process as claimed in claim 15, wherein the remote system includes a web server.

17. A process as claimed in claim 15, wherein the remote system includes an e-commerce or auction system.

18. A process as claimed in claim 1, further including receiving identification data of a label attached to a selected component of said article to identify the selected component and the corresponding article.

19. A process as claimed in claim 18, including scanning the selected label to determine said identification data.

20. An inventory process, including generating a set of identification labels for attachment to respective components of an article, each of said identification labels including identification data identifying a corresponding component of said article.

21. A process as claimed in claim 20, including:
selecting an article type of on the basis of received type selection data;
generating a list of possible components of an article of the selected type; and
generating said set of identification labels on the basis of said list.

22. A process as claimed in claim 1, wherein said set of identification labels includes identification data specific to components of an article of a selected type.

23. A process as claimed in claim 22, wherein the type of an article includes a make, model, and/or date of said article.

24. A process as claimed in claim 1, wherein the set of identification labels includes identification labels identifying respective attributes for at least one component of an article.

25. A process as claimed in claim 1 wherein each identification label of said set of identification labels identifies a corresponding component of said article and at least one attribute of said component, so that said inventory data identifies each received component and at least one corresponding attribute.

26. A process as claimed in claim 22, wherein said attribute includes a condition of said component.

27. A process as claimed in claim 1 wherein said inventory data identifies the components of said article and said article.

28. A process as claimed in claim 1, wherein each of the identification labels of said set identifies a corresponding article and a corresponding component of said article.

29. A process as claimed claim 1, wherein the identification data of each identification label identifies a corresponding article type and a corresponding component of an article of said type.

30. A process as claimed in claim 1, wherein the identification data includes numeric identification data unique to each component.

31. A process as claimed in claim 30, wherein the numeric identification data includes a barcode.

32. A process as claimed in claim 1, wherein at least part of the identification data is stored in one or more RFID tags of the set of identification labels.

33. A process as claimed in claim 1, wherein the identification labels of said set are provided in one or more sheets of adhesive identification labels.

34. A process as claimed in claim 1, wherein the identification labels of said set are arranged in groups corresponding to respective portions of said article, each of said portions including a plurality of components of said article.

35. A process as claimed in claim 1, wherein the article includes a vehicle.

36. A system having components for executing the steps of claim 1.

37. A computer readable storage medium having stored thereon program instructions for executing the steps of claim 1.

38. An inventory system for determining receipt of components of an article, the components having identification labels of a set of labels attached thereto, the system being adapted to generate inventory data identifying receipt of said components on the basis of the remaining identification labels of said set.

39. An inventory system adapted to generate inventory data identifying components of a received article on the basis of identification data of one or more identification labels of a set of identification labels, the other labels of said set of identification labels having been attached to respective components of said received article.

40. The system claimed in claim 38, including a printing component for printing said set of identification labels for attachment to respective components of an article of a selected type, each of said labels including identification data for identifying a corresponding component of an article of said type.

41. The system claimed in claim 38, including a scanning component for determining identification data of said identification labels.

42. The system claimed in claim 41, wherein said scanning component includes an optical scanning component.

43. The system claimed in claim 42, wherein said optical scanning component includes a barcode scanner.

44. The system claimed in claim 41, wherein said scanning component includes an RFID scanning component.

45. A set of identification labels for attachment to respective components of an article, each of said identification labels including identification data identifying a corresponding component of said article.

46. A set of identification labels as claimed in claim 45, wherein the identification data of each identification label identifies a corresponding article type and a corresponding component of an article of said type.

47. A set of identification labels as claimed in claim 45, wherein each of the identification labels includes a barcode providing at least part of the identification data.

48. A set of identification labels as claimed in claim 45, wherein at least part of the identification data is stored in one or more RFID tags of the set of identification labels.

49. A set of identification labels as claimed in claim 45, wherein the identification labels of said set are provided in one or more sheets of adhesive identification labels.

50. A set of identification labels as claimed in claim 45, wherein the identification labels of said set are arranged in groups corresponding to respective portions of said article, each of said portions including a plurality of components of said article.
